(19) United States
(12) Patent Application Publication
(10) Pub. No.: US 2013/0193762 A1
(43) Pub. Date: Aug. 1, 2013

(54) THREE-LEVEL POWER CONVERTING APPARATUS

(71) Applicant: Fuji Electric Co., Ltd., Kawasaki-shi (JP)

(72) Inventors: Kansuke FUJII, Kobe-city (JP); Yoshitaka HAMADA, Kanagawa (JP); Yasunao SAGA, Kobe-city (JP)

(73) Assignee: FUJI ELECTRIC CO., LTD., Kawasaki-shi (JP)

(21) Appl. No.: 13/740,155

(22) Filed: Jan. 11, 2013

(30) Foreign Application Priority Data
Jan. 27, 2012 (JP) 2012-015142

(51) Int. Cl. H02J 1/00

(52) U.S. Cl. CPC H02J 1/00
USPC 307/64

(57) ABSTRACT

In a three-level power converting apparatus, a U-phase control means of a first control means operates with a control power supply. A control power supply voltage decrease detecting means and a second control means operate with a gate-driving power supply. A U-phase control means conducts PWM operation using a modulation signal λ from a modulation signal generating means and a carrier signal from a carrier signal generating means and generates control signals for a plurality of switching elements. The second control means generates gate signals from the control signals. When the control power supply voltage decrease detecting means delivers a control power supply voltage decrease signal, the second control means generates the gate signals to turn ones of the switching elements OFF and turn others of the switching elements ON for a predetermined period of time.

### CROSS-REFERENCE TO RELATED APPLICATION

This application is based on, and claims priority to, Japanese Patent Application No. 2012-015142, filed on Jan. 27, 2012, contents of which are incorporated herein by reference.

### BACKGROUND OF THE INVENTION

1. Field of the Invention

The present invention relates to a power converting apparatus, in particular to a three-level power converting apparatus for converting DC voltage into three-level AC voltage.

2. Description of the Related Art

FIG. 10 shows a construction of a main circuit of a three-phase, three-level inverter disclosed in Patent Document 1 (identified below).

The voltage of a DC power supply 1 is divided into two halves with series-connected capacitors 2A and 2B. The 3U, 3V, and 3W are switching legs of three phases U-phase, V-phase, and W-phase. Each switching leg comprises switching elements T1, T4, T3, and T2 series-connected in this order and diodes D1 and D2. The switching elements T1 through T4 are IGBTs (insulated gate bipolar transistors) with antiparallel-connected diodes.

The series-connected circuit of the switching elements is connected between the end terminals of the series-connected circuit of the capacitors 2A and 2B. The diode D1 is connected between the connection point of the capacitors 2A and 2B and the connection point of the switching elements T1 and T4. The diode D2 is connected between the connection point of the capacitors 2A and 2B and the connection point of the switching elements T3 and T2. The connection point of the switching elements T4 and T3 is an AC output terminal U, V, or W of each switching leg.

The switching elements T1 through T4 of the U-phase switching leg 3U conduct ON-OFF operation according to gate signals G1U through G4U; the switching elements T1 through T4 of the V-phase switching leg 3V conduct ON-OFF operation according to gate signals G1V through G4V; and the switching elements T1 through T4 of the W-phase switching leg 3W conduct ON-OFF operation according to gate signals G1W through G4W.

The ON-OFF operation of the switching elements delivers phase voltages having three-level electric potential from the AC output terminals U, V, and W to a load 4.

FIG. 11 is a block diagram showing a construction of a control circuit of a three phase, three-level inverter disclosed in Patent Document 1.

A first control means 5 generates: control signals S1U through S4U for turning ON and OFF the switching elements T1 through T4 of the switching leg 3U, control signals S1V through S4V for turning ON and OFF the switching elements T1 through T4 of the switching leg 3V, and control signals S1W through S4W for turning ON and OFF the switching elements T1 through T4 of the switching leg 3W.

A second control means 6 converts: the control signals S1U through S4U into gate signals G1U through G4U, the control signals S1V through S4V into gate signals G1V through G4V, and the control signals S1W through S4W into gate signals G1W through G4W.

The first control means 5 and the second control means 6 are operated with the voltage from a control power supply 7.

In the three-phase, three-level inverter having the main circuit and the control circuit described above, the second control means 6 further comprises a voltage decrease detecting means, first and second latching means, and a first timer means. The second control means 6 generates gate signals for the switching elements T3 and T4 of each switching leg to turn OFF later than the switching elements T1 and T2 when the voltage from the control power supply 7 decreases. This avoids application of overvoltage higher than the withstand voltage of the first and second switching elements even when the voltage from the control power supply 7 decreases.

### [Patent Document 1]

Japanese Unexamined Patent Application Publication No. 2011-147316

The control circuit of the three-level inverter disclosed in Patent Document 1, however, operates the second control means 6 with the voltage from the control power supply 7. Consequently, if the voltage of the control power supply 7 decreases rapidly, the second control means cannot generate the gate signal to turn OFF the switching elements T3 and T4 later than the switching elements T1 and T2 of each switching leg.

### SUMMARY OF THE INVENTION

The present invention has been made in view of the problem described above and an object of the invention is to provide a three-level power converting apparatus that generates gate signals to turn OFF the switching elements T3 and T4 later than the switching elements T1 and T2 of each switching leg even though the voltage of the control power supply 7 decreases rapidly.

To achieve the above-described object, according to one aspect of the embodiments of the present invention is a three-level power converting apparatus including a switching leg having a first circuit and a second circuit. The first circuit includes a first switching element and a second switching element connected in series between a high potential terminal and a low potential terminal of a DC power supply. The second circuit includes a third switching element and a fourth switching element connected in antiparallel with each other between a middle potential terminal and a middle connection point in the first circuit.

The three level power converting apparatus further includes a first control means and a first power supply. The first control circuit generates a first control signal for controlling the first switching element, a second control signal for controlling the second switching element, a third control signal for controlling the third switching element, a fourth control signal for controlling the fourth switching element. The first control means operates at the voltage of the first power supply.

The three level power converting apparatus further includes a second control means and a second power supply. The second control means generates a first gate signal based on the first control signal, a second gate signal based on the second control signal, a third gate signal based on the third control signal, a fourth gate signal based on the fourth control signal. The second control means operates at the voltage of the second power supply.

When the first power supply for operating the first control means enters (e.g., takes on, assumes) an abnormal state, the second control means generates the first and second gate signals that substantially immediately turn OFF the first and second switching elements. The second control means further generates the third control signal that turns the third switching element ON for a predetermined period of time when the second switching element turns OFF, and turns the third switching element OFF after expiration of the predetermined period of time. The second control means still further generates the fourth control signal that turns the fourth switching element ON for a predetermined period of time when the first switching element turns OFF, and turns the fourth switching element OFF after expiration of the predetermined period of time.

Another aspect of the embodiments of the present invention is a three-level power converting apparatus including a third circuit, a first diode and a second diode. The third circuit includes a switching leg connected between a high potential terminal and a low potential terminal of a DC power supply. The third circuit includes, sequentially connected, a first switching element, a fourth switching element, a third switching element, and a second switching element in series. The first diode is connected between a middle potential terminal and a connection point of the first switching element and the fourth switching element. The second diode is connected between the middle potential terminal and a connection point of the third switching element and the second switching element.

The three level power converting apparatus further includes a first control means and a first power supply. The first control circuit generates a first control signal for controlling the first switching element, a second control signal for controlling the second switching element, a third control signal for controlling the third switching element, a fourth control signal for controlling the fourth switching element. The first control means operates at the voltage of the first power supply.

The three level power converting apparatus further includes a second control means and a second power supply. The second control means generates a first gate signal based on the first control signal, a second gate signal based on the second control signal, a third gate signal based on the third control signal, a fourth gate signal based on the fourth control signal. The second control means operates at the voltage of the second power supply.

When the first power supply for operating the first control means enters an abnormal state, the second control means generates the first and second gate signals that substantially immediately turn OFF the first and second switching elements. The second control means further generates the third control signal that turns the third switching element ON for a predetermined period of time when the second switching element turns OFF, and turns the third switching element OFF after expiration of the predetermined period of time. The second control means still further generates the fourth control signal that turns the fourth switching element ON for a predetermined period of time when the first switching element turns OFF, and turns the fourth switching element OFF after expiration of the predetermined period of time.

According to the aspect of the embodiments of the present invention described above, the first and the second control means operate with voltage of separate power supplies. When the voltage of the first power supply decreases, resulting in unstable operation of the first control means, the second control means makes it possible to generate gate signals for the first through fourth switching elements. The second control means generates gate signals to turn OFF the first switching element and the second switching element. The second control means also generates gate signals to turn the third switching element and the fourth switching element ON once for a predetermined period of time and then OFF.

Therefore, even when the voltage of the first power supply (a control power supply) decreases, the first switching element and the second switching element are prevented from being subjected to the whole of the voltage of the DC power supply.

### BRIEF DESCRIPTION OF THE DRAWINGS

FIG. 1 illustrates a main circuit structure of a three-level inverter of an embodiment according to the present invention;

FIG. 2 is a block diagram illustrating a control circuit of an embodiment according to the present invention;

FIG. 3 illustrates operation of the control circuit in a normal state of control power supply voltage;

FIG. 4 illustrates operation of the control circuit in response to control power supply voltage decrease;

FIG. 5 illustrates a circuit for T1 in a second control means;

FIG. 6 illustrates a circuit for T2 in a second control means;

FIG. 7 illustrates another structure of a main circuit of a three-level inverter;

FIG. 8 is a block diagram illustrating a control circuit of another embodiment according to the present invention;

FIG. 9 is a block diagram illustrating a control circuit of still another embodiment according to the present invention;

FIG. 10 illustrates a main circuit structure of a three-level inverter according to conventional technology; and

FIG. 11 is a block diagram illustrating a control circuit according to conventional technology.

### DETAILED DESCRIPTION OF THE INVENTION

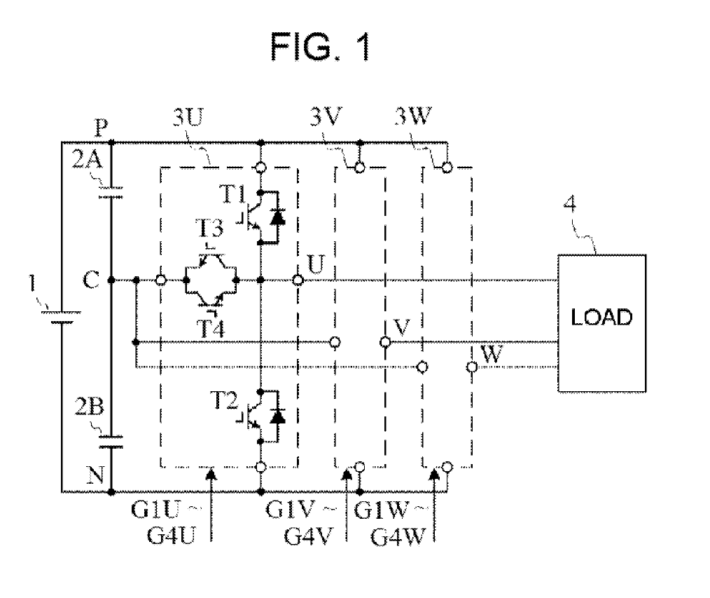

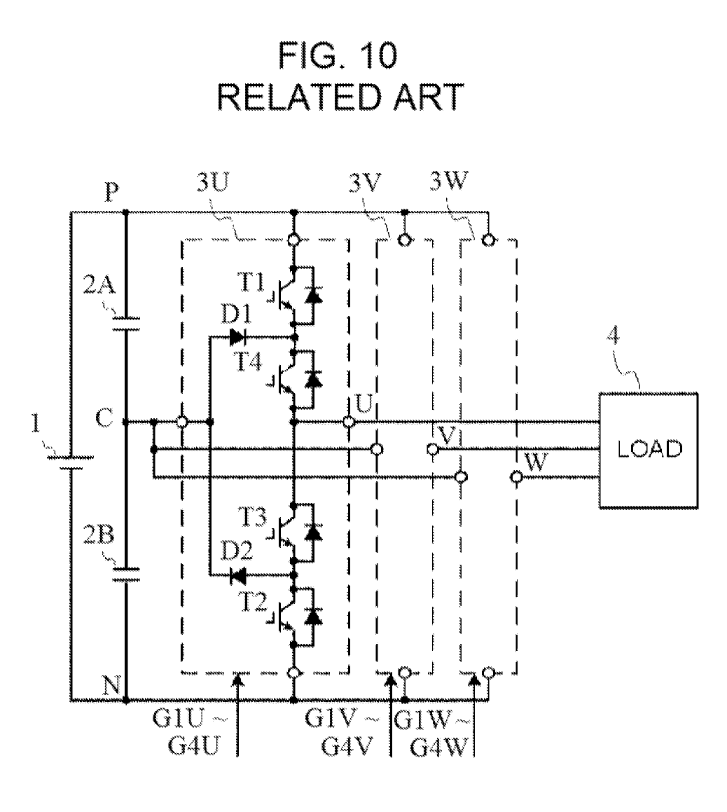

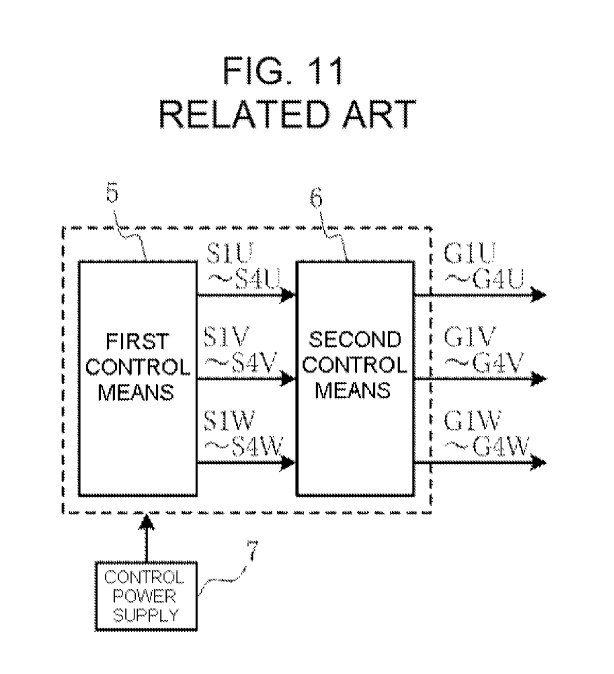

Now, some preferred embodiments according to the present invention will be described in detail in the following with reference to the accompanied drawings of FIGS. 1 through 9. In the FIGS. 1 through 9, the same components are given the same symbols as those in FIGS. 10 and 11.

FIG. 1 illustrates a main circuit structure of a three-level inverter for converting the voltage of a DC power supply 1 into three-level, three-phase AC voltage to supply to a load 4. The main circuit of this three-level inverter comprises capacitors 2A and 2B, and switching legs 3U, 3V and 3W.

The capacitors 2A and 2B are connected in series between a high potential side terminal P and a low potential side terminal N of the DC power supply 1. The connection point of the capacitors 2A and 2B is a terminal C that outputs a middle electric potential of the DC power supply 1. The voltage of the DC power supply 1 is divided into two voltages: the voltage across the capacitor 2A and the voltage across the capacitor 2B.

In the following description, let the voltage of the DC power supply be 2E, the voltage between the high potential side terminal P and the middle potential terminal C be E, and the voltage between the middle potential terminal C and the low potential side terminal N be E.

The switching leg 3U of the U-phase comprises a first circuit and a second circuit. The first circuit is composed of a switching element T1, which is a first switching element, and a switching element T2, which is a second switching element, series-connected to each other. The switching element T1 and the switching element T2 are IGBTs with an antiparallel-connected diode. The second circuit is composed of a switching element T3, which is a third switching element, and a switching element T4, which is a fourth switching element, anti-parallel-connected to each other. The switching element T3 and the switching element T4 are reverse-blocking type IGBTs.

The first circuit is connected between the high potential side terminal P and the low potential side terminal N. The second circuit is connected between the middle potential terminal C and a middle connection point of the first circuit. The middle connection point of the first circuit is the AC output terminal U of the U-phase switching leg 3U.

The V-phase switching leg 3V is constructed similarly to the U-phase switching leg 3U. The middle connection point of the first circuit of the V-phase switching leg 3V is the AC output terminal V of the V-phase switching leg 3V.

The W-phase switching leg 3W is constructed similarly to the U-phase switching leg 3U. The middle connection point of the first circuit of the W-phase switching leg 3W is the AC output terminal W of the W-phase switching leg 3W.

The AC output terminals U, V, and W are connected to the load 4.

The switching elements T1 through T4 of the switching leg 3U conduct ON-OFF operation according to the gate signals G1U through G4U. The switching elements T1 through T4 of the switching leg 3V conduct ON-OFF operation according to the gate signals G1V through G4V. The switching elements T1 through T4 of the switching leg 3W conduct ON-OFF operation according to the gate signals G1W through G4W.

The gate signals G1U through G4U, G1V through G4V, and G1W through G4W are generated in a control circuit described later.

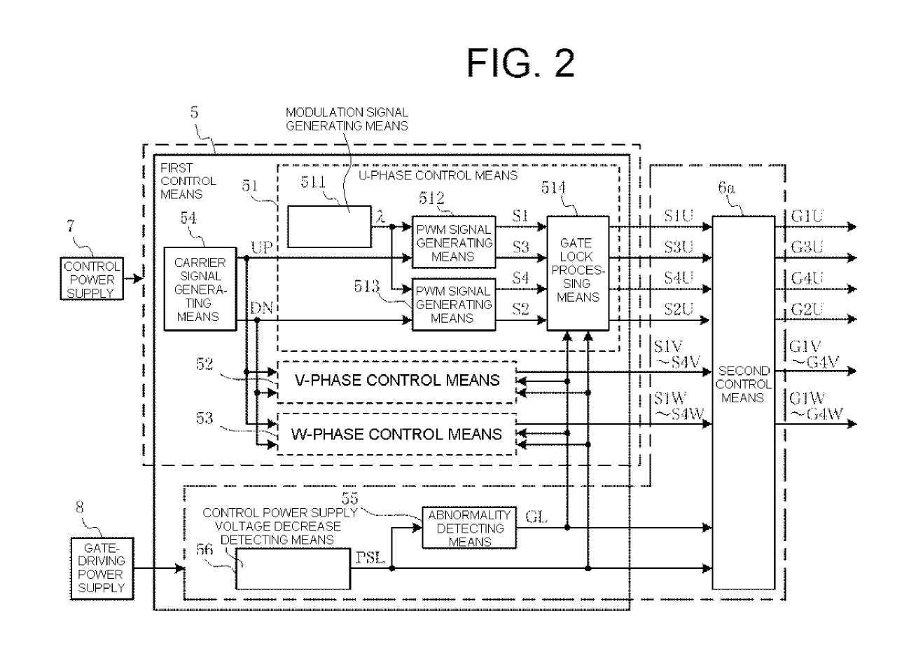

FIG. 2 is a block diagram illustrating an embodiment of a circuit for controlling the three-level inverter shown in FIG. 1.

The control circuit of FIG. 2 comprises: a first control means 5, a second control means 6a, a control power supply 7, which is a first power supply, and a gate-driving power supply 8, which is a second power supply. The gate-driving power supply 8 drives switching elements T1 through T4 of the switching legs 3U, 3V, and 3W.

The first control means 5 comprises: a U-phase control means 51, a V-phase control means 52, a W-phase control means 53, a carrier signal generating means 54, an abnormality detecting means 55, and a control power supply voltage decrease detecting means 56.

The U-phase control means 51 comprises: a modulation signal generating means 511, PWM signal generating means 512 and 513, and a gate lock processing means 514. The V-phase control means 52 and the W-phase control means 53 have the same structure and perform the similar functions as the U-phase control means 51.

The abnormality detecting means 55 detects abnormality of the three-level inverter, for example overcurrent and overheating of the switching element, and delivers an abnormality signal GL. When the abnormality signal GL is at a low level (an L-level), the three-level inverter is in a normal state. When the abnormality signal GL is at a high level (an H-level), the three-level inverter is in an abnormal state and needs to stop its operation.

The control power supply voltage decrease detecting means 56 detects voltage decrease of the control power supply 7 below a predetermined value and delivers a control power supply voltage decrease signal PSL.

When the control power supply voltage decrease signal PSL is at an L-level, the voltage of the control power supply 7 is above the predetermined value and in a normal state. When the control power supply voltage decrease signal PSL is at an H-level, the voltage of the control power supply is below the predetermined value and in an abnormal state. When the voltage of the control power supply 7 decreases below the predetermined value, the first control means 5 is unable to operate stably. Consequently, the three-level inverter needs to stop its operation.

In the construction of the control circuit of FIG. 2, the U-phase control means 51, the V-phase control means 52, the W-phase control means 53, and the carrier signal generating means 54 operate with the voltage of the control power supply 7. On the other hand, the second control means 6a, the abnormality detecting means 55, and the control power supply voltage decrease detecting means 56 operate with the voltage of the gate-driving power supply 8.

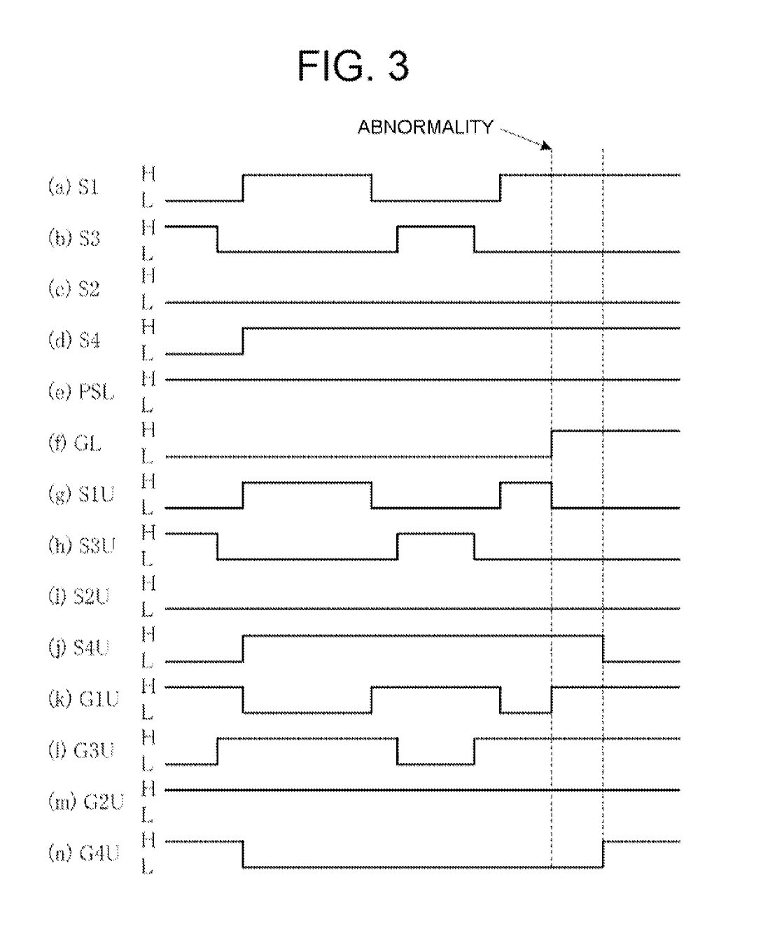

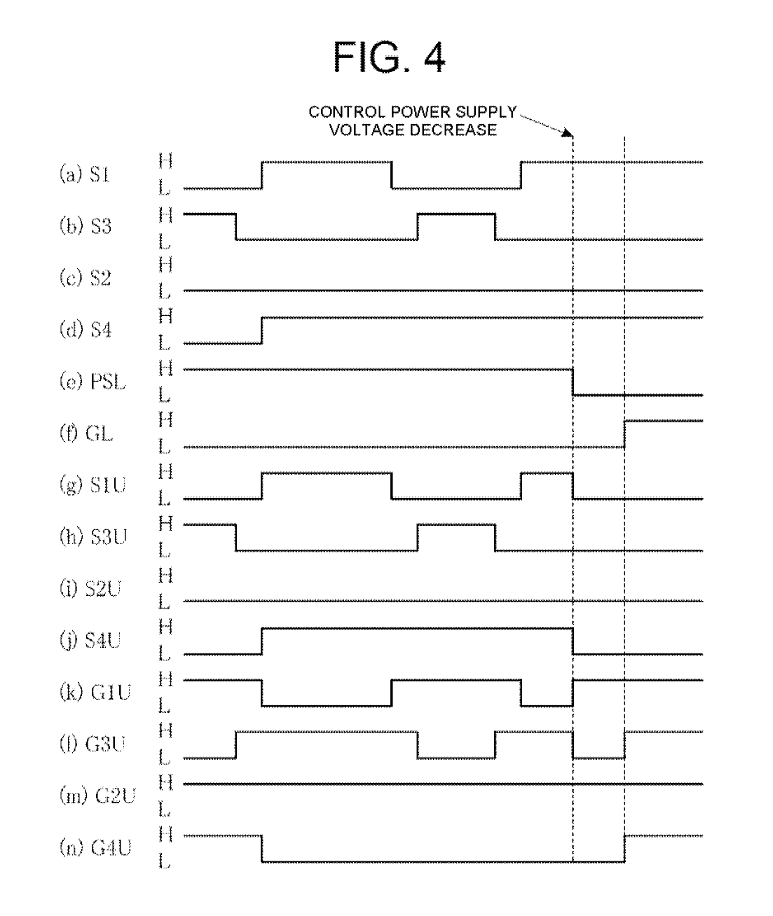

The following describes operation of a power converting apparatus of the present invention mainly concerning the main circuit and the control circuit of the U-phase with reference to FIG. 3 and FIG. 4.

FIG. 3 illustrates the operation of the control circuit in the normal state of the voltage of the control power supply 7.

The carrier signal generating means 54 generates a carrier signal UP and a carrier signal DN. The carrier signal UP and the carrier signal DN are at the same phase and shifted vertically.

The modulation signal generating means 511 generates a modulation signal λ. The modulation signal λ instructs (e.g., determines) the magnitude of AC voltage delivered from the AC output terminal U of the switching leg 3U. The modulation signal λ varies between the level at the bottom of the carrier signal DN and the level at the top of the carrier signal UP.

The PWM signal generating means 512 receives the modulation signal λ and the carrier signal UP, and conducts PWM operation to deliver a control signal S1 for the switching element T1 and a control signal S3 for the switching element T3.

When the modulation signal λ is a positive value, the control signal S1 and the control signal S3 takes complimentarily an H-level or an L-level as indicated in FIG. 3, (a) and (b). The switching element T1 takes an ON state when the control signal S1 is at an H-level, and the switching element T1 takes an OFF state when the control signal S1 is at an L-level. Similarly, switching element T3 takes an ON state when the control signal S3 is at an H-level, and the switching element T3 takes an OFF state when the control signal S3 is at an L-level. The control signal S1 and the control signal S3 have a suspension period of time in which the two signals are simultaneously at an L-level. This suspension period of time is set in order to prevent the switching element T1 and the switching element T3 from simultaneously taking an ON state.

The PWM signal generating means 513 receives the modulation signal λ and the carrier signal DN, and conducts PWM operation to deliver a control signal S2 for the switching element T2 and a control signal S4 for the switching element T4.

When the modulation signal λ is a negative value, the control signal S2 and the control signal S4 takes complimentarily an H-level or an L-level as indicated in FIG. 3, (c) and (d). The switching element T2 takes an ON state when the control signal S2 is at an H-level, and the switching element T2 takes an OFF state when the control signal S2 is at an L-level. Similarly, switching element T4 takes an ON state when the control signal S4 is at an H-level, and the switching element T4 takes an OFF state when the control signal S4 is at an L-level. The control signal S2 and the control signal S4 have a suspension period of time in which the two signals are simultaneously at an L-level.

When the modulation signal λ is a positive value, the control signal S4 is always at an H-level, while when the modulation signal λ is a negative value, the control signal S3 is always at an H-level.

When the abnormality detecting means 55 does not detect an abnormality of the three-level inverter, the abnormality signal GL is at an L-level. In this case, the gate lock processing means 514 delivers the control signals S1 through S4 as control signals S1U through S4U, as indicated in FIG. 3, (g) through (j). The abnormality detected by the abnormality detecting means 55 is, for example, overcurrent, or overheating of the switching elements.

The second control means 6a generates gate signals G1U through G4U for the switching elements T1 through T4 using the control signal S1U through S4U as indicated in FIG. 3, (k) through (n). The gate signals G1U through G4U are generated by inverting the H-level and the L-level of the control signals S1U through S4U. Consequently, the switching element is in an ON state when the gate signal is at the L-level, and the switching element is in an OFF state when the gate signal is at H-level.

When the voltage of the control power supply 7 is in a normal state and the abnormality detecting means 55 detects the abnormality of the three-level inverter, the control circuit operates as follows. Here, the control power supply voltage decrease signal PSL is at an H-level when the voltage of the control power supply 7 is in a normal state. The abnormality detecting signal GL is at an H-level when the abnormality detecting means 55 detects the abnormality of the three-level inverter.

At the moment immediately before the abnormality signal GL turns to an H-level, the control signal S1U and S4U are at an H-level, consequently the gate signals G1U and G4U are at an L-level; the control signal S2U and S3U are at an L-level, consequently the gate signals G2U and G3U are at an H-level. Thus, the switching elements T1 and T4 are in the ON state and the switching elements T2 and T3 are in the OFF state. As a result, the AC output terminal U gives an electric potential of 2E. An electric current is flowing from the capacitor 2A through the switching element T1 to the load 4.

When the abnormality signal GL turns to an H-level from this state, the gate lock processing means 514 changes the control signal S1U from an H-level to an L-level. The gate lock means 514 holds the control signals S2U and S3U at an L-level, and holds the control signal S4U at an H-level.

By controlling the control signals S1U through S4U like this, the switching element T1 turns OFF in the states of the switching element T4 ON and the switching elements T2 and T3 OFF. Since the switching element T4 is in the ON state, the electric potential at the AC output terminal U is clamped at the middle potential terminal C of potential E. Therefore, the switching element T1 is not subjected to the whole voltage 2E of the DC power supply 1.

The gate lock processing means 514 changes the control signal S4U to an L-level after a predetermined time from receiving the abnormality signal GL. This turns the switching element T4 OFF. Thus, all the switching elements enter the OFF state. The time duration from the change of the abnormality signal GL into an H-level to the change of the control signal S4U into an L-level is set to be longer than the time duration of completion of turning OFF operation of the switching element T1.

If the abnormality signal GL changes to an H-level in the state of the control signal S2U and S3U at an H-level and the control signals S1U and S4U at an L-level, the first control means 5 and the second control means 6a operate with a logical sequence similar to that described above. Therefore, in this case too, the switching element T2 is not subjected to the whole voltage 2E of the DC power supply 1.

Next, the operation in the case the voltage of the control power supply 7 decreases will be described referring to FIG. 4.

Referring to FIG. 4, the states of the control signals until the voltage of the control power supply 7 decreases are the same as those in the operation before the abnormality occurs as described above referring to FIG. 3. At the moment immediately before the control power supply voltage decrease signal PSL of changes to an L-level, the control signals S1U and S4U are at an H-level, consequently the gate signals G1U and G4U are at an L-level; and the control signal S2U and S3U are at an L-level, consequently the gate signals G2U and G3U are at an H-level. The switching elements T1 and T4 are in the ON state and the switching elements T2 and T3 are in the OFF state. As a result, the AC output terminal U gives an electric potential of 2E. Electric current flows from the capacitor 2A through the switching element T1 to the load 4.

When the control power supply voltage decrease signal PSL changes to an L-level from this state, the gate lock processing means 514 changes all the control signals S1U through S4U to the L-level.

The second control means 6a changes the gate signals G1U and G2U for the switching elements T1 and T2 to an H-level according to the control signals S1U and S2U. Thus, the switching elements T1 and T2 turn OFF. The second control means 6a, on the other hand, changes the gate signals G3U and G4U for the switching elements T3 and T4 forcedly to an L-level. This turns the switching elements T3 and T4 ON.

If the switching element T3 turns ON before the completion of turn OFF of the switching element T1, overcurrent would flow. To avoid the occurrence of the overcurrent, it is preferable to set a time lag between the timing of turning OFF of the switching element T1 and the timing of turning ON of the switching element T3. Similarly, it is preferable to set a time lag between the timing of turning OFF of the switching element T2 and the timing of turning ON of the switching element T4.

The switching element T3 or T4 is preferably held in the OFF state corresponding to the switching element T1 or T2 that has been in the OFF state. By holding the OFF state, the overcurrent can be avoided.

Owing to the above-described operation of the first control means 5 and the second control means 6a, the switching element T1 can be turned OFF in the ON state of the switching element T4, and the switching element T2 can be turned OFF in the ON state of the switching element T3.

In this state of the switching elements T3 and T4 in the ON state, the potential of the AC output terminal U is clamped at the potential E of the middle potential terminal C. Therefore, the switching elements T1 and T2 is not subjected to the whole voltage 2E of the DC power supply 1.

The second control means 6a changes the gate signals G3U and G4U into an H-level after a predetermined period of time from receiving the control power supply voltage decrease signal PSL. Thus, the switching elements T3 and T4 turn OFF, making all the switching elements be in an OFF state.

In the case the control power supply voltage decrease signal PSL changes to an L-level in the state of the control signals S2U and S3U at an H-level and the control signals S1U and S4U at an L-level, the first control means 5 and the second control means 6a operate in a logical sequence similar to that described above. Therefore, the switching element T2 is not subjected to the whole voltage 2E of the DC power supply 1 in this case, too.

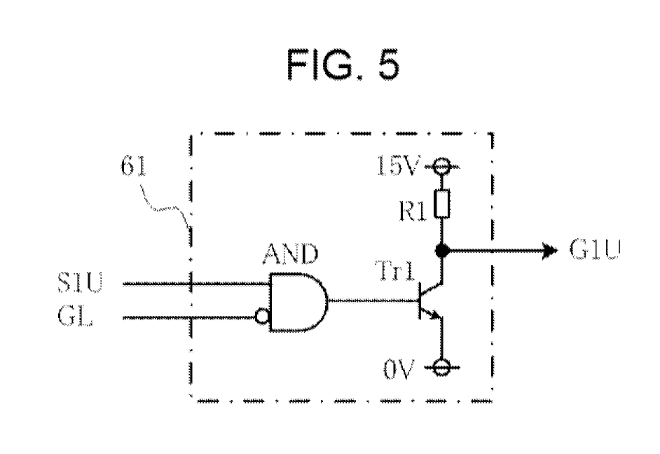

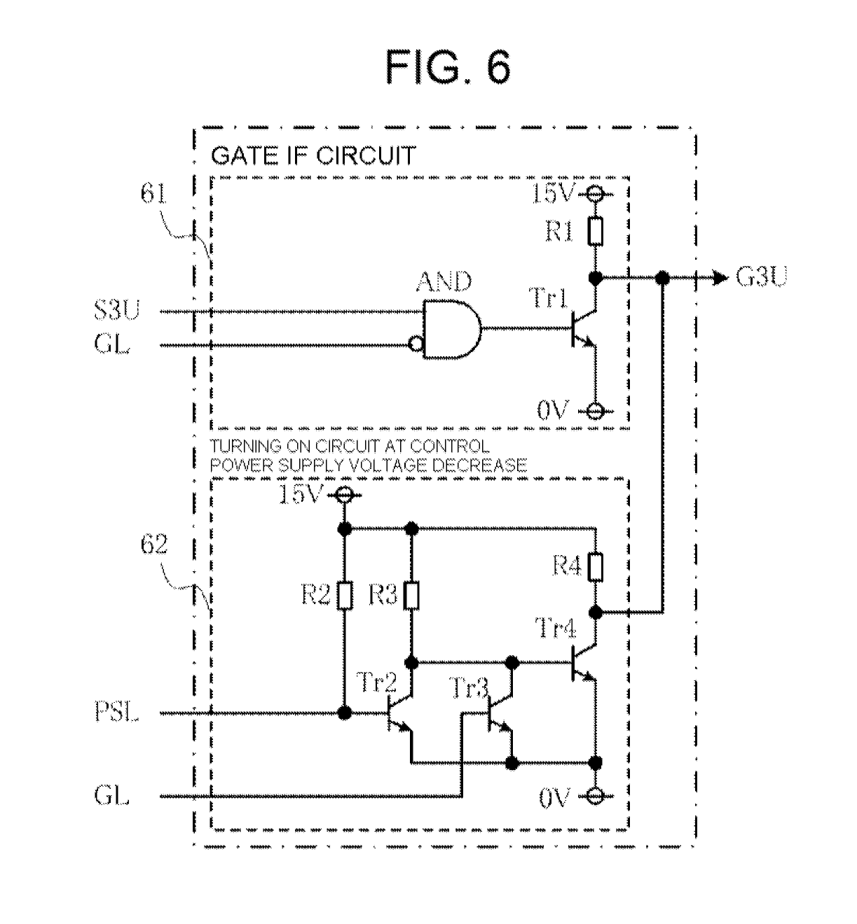

More specific description about the second control means 6a will be made in the following with reference to FIGS. 5 and 6.

FIG. 5 shows an example of a gate IF circuit 61 of the second control means 6a, the gate IF circuit 61 generating the gate signal G1U for the switching element T1.

In this circuit of FIG. 5, the collector terminal of transistor Tr1 is an output terminal of the G1U. The collector terminal of the transistor Tr1 is pulled up with the resistor R1 to the 15 [V] terminal of the gate-driving power supply 8. The emitter terminal is connected to the 0 [V] terminal of the gate-driving power supply 8. The gate signal G1U is at an H-level when the voltage at the collector terminal of the transistor Tr1 is 15 [V], and at an L-level when the voltage is 0 [V].

The gate IF circuit 61 of FIG. 5 receives the control signal S1U from the gate lock processing means 514 and the abnormality signal GL from the abnormality detecting means 55. The control signal S1U is given to the non-inversion terminal of the logical product operator AND. The abnormality signal GL is given to the inversion terminal of the logical product operator AND.

The logical product operator AND delivers an H-level signal receiving an H-level signal at the non-inversion terminal and an L-level signal at the inversion terminal. The logical product operator AND delivers an L-level signal receiving an L-level signal at the non-inversion terminal or an H-level signal at the inversion terminal.

Description is first made about operation in a normal state of the three-level inverter.

In the normal state of the three-level inverter, the abnormality signal GL is at an L-level. Consequently, the logical product operator AND delivers an H-level signal when the control signal S1U is at an H-level. The logical product operator AND delivers an L-level signal when the control signal S1U is at an L-level.

When the output signal from the logical product operator AND is at an H-level, base current flows into the transistor Tr1 and the transistor Tr1 is in the ON state. The ON state of the transistor Tr1 makes the gate signal G1U at 0 [V] or an L-level. On the other hand, when the logical product operator AND delivers an L-level signal, base current does not flow into the transistor Tr1, and the transistor Tr1 is in the OFF state. The OFF state of the transistor Tr1 makes the gate signal G1U at 15 [V] or an H-level. Thus, the gate signal G1U is at an H-level when the control signal S1U is at an L-level; and the gate signal G1U is at an L-level when the control signal S1U is at an H-level.

Next, operation in an abnormal state of the three-level inverter is described.

In the abnormal state of the three-level inverter, the abnormality signal GL is at an H-level. In this state, the output from the logical product operator AND is fixed to an L-level. Since base current does not flow into the transistor Tr1, the transistor Tr1 is in the OFF state. Because of the OFF state of the transistor Tr1, the gate signal G1U is at 15 [V] or an H-level. Thus, the gate signal G1U is always at an H-level.

A circuit to generate the gate signal G2U for the switching element T2 has the same construction as the gate IF circuit 61 to generate the gate signal G1U for the switching element T1 shown in FIG. 5. Accordingly, the circuit to generate the gate signal G2U for the switching element T2 operates in the same manner as the gate IF circuit 61.

FIG. 6 shows an example of a circuit to generate a gate signal G3U for the switching element T3, the circuit being a component circuit of the second control means 6a.

This circuit of FIG. 6 comprises a gate IF circuit 61 and a turning ON circuit at control power supply voltage decrease 62. The output point of the gate IF circuit 61 and the output point of the turning ON circuit at control power supply voltage decrease 62 are connected. The signal at this connection point is the gate signal G3U.

The output terminal of the gate IF circuit 61 is the collector terminal of the transistor Tr1. The collector terminal of the transistor Tr1 is pulled up with a resistor R1 to the 15 [V] terminal of the gate-driving power supply 8 and the emitter terminal of the transistor Tr1 is connected to the 0 [V] terminal of the gate-driving power supply 8.

The output terminal of the turning ON circuit at control power supply voltage decrease 62 is the collector terminal of the transistor Tr4. The collector terminal of the transistor Tr4 is pulled up with a resistor R4 to the 15 [V] terminal of the gate-driving power supply 8 and the emitter terminal is connected to the 0 [V] terminal of the gate-driving power supply 8.

Thus, the gate signal G3U is at an L-level when one of the two transistors Tr1 and the Tr4 is in the ON state and at an H-level when the two transistors are both in the OFF state.

The gate IF circuit 61 in FIG. 6 receives the control signal S3U from the gate lock processing means 514 and the abnormality signal GL from the abnormality detecting means 55. The control signal S3U is given to the non-inversion terminal of the logical product operator AND. The abnormality signal GL is given to the inversion terminal of the logical product operator AND through a delay means.

The logical product operator AND delivers an H-level signal based on receiving an H-level signal at the non-inversion terminal and an L-level signal at the inversion terminal. The logical product operator AND delivers an L-level signal based on receiving an L-level signal at the non-inversion terminal or an H-level signal at the inversion terminal.

The operation is first described for the case the three-level inverter is normal and the voltage of the control power supply is also normal.

When the three-level inverter is normal, the abnormality signal GL is at an L-level. Consequently, the logical product operator AND delivers an H-level signal when the control signal S3U is at an H-level. If the control signal S3U is at an L-level, the logical product operator AND delivers an L-level signal.

When the logical product operator AND delivers an H-level signal, base current flows into the transistor Tr1, turning ON the transistor Tr1. The ON state of the transistor Tr1 causes the gate signal G1U to be at 0 [V] or an L-level. If the logical product operator AND delivers an L-level signal, on the other hand, the base current does not flow into the transistor Tr1, resulting in the OFF state of the transistor Tr1. The OFF state of the transistor Tr1 causes the gate signal G1U to be 15 [V] or an H-level. Thus, the gate signal G1U is at an H-level when the control signal S1U is at an L-level; and the gate signal G1U is at an L-level when the control signal S1U is at an H-level.

The turning ON circuit at control power supply voltage decrease 62 receives the control power supply voltage decrease signal PSL from the control power supply voltage decrease detecting means 56 and the abnormality signal GL from the abnormality detecting means 55.

The abnormality signal GL is given to the base terminal of the transistor Tr3. When the three-level inverter is in a normal state, the abnormality signal GL is at an L-level, and base current does not flow into the transistor Tr3, causing the transistor Tr3 to be in the OFF state.

The control power supply voltage decrease signal PSL is given to the base terminal of the transistor Tr2. The base terminal of the transistor Tr2 is pulled up with the resistor R2 to the 15 [V] terminal. When the voltage of the control power supply is in a normal state, the control power supply voltage decrease signal PSL is at an H-level, and the base current flows into the transistor Tr2, causing the transistor Tr2 to be the ON state.

The base terminal of the transistor Tr4 is pulled up with the resistor R3 to the 15 [V] terminal. When the transistor Tr2 is in the ON state and the transistor Tr3 is in the OFF state, the base current does not flow into the transistor Tr4, causing the transistor Tr4 to be the OFF state.

When the Tr1 is in the OFF state, the gate signal G3U is at an H-level since the transistor Tr4 is in the OFF state. When the transistor Tr1 is in the ON state, the gate signal G3U is at an L-level.

Thus, in the normal state of the three-level inverter and the normal state of the voltage of the control power supply, the gate signal G3U is at an H-level when the control signal S3U is at an L-level, and the gate signal G3U is at an L-level when the control signal S3U is at an H-level.

Next, the operation is described for the case the voltage of the control power supply is decreased.

In this case, the abnormality signal GL is at an L-level in the period from the moment the control power supply voltage decrease signal PSL changes from an H-level to an L-level until the moment a predetermined time has passed.

Thus, the operation of the transistor Tr1 of the gate IF circuit 61 is the same as the one in the normal state of the three-level inverter; the transistor Tr1 is in the ON state when the control signal S1U is at an H-level; and the transistor Tr1 is in the OFF state when the control signal S1U is at an L-level.

At the moment a predetermined period of time has passed from the transition of the control power supply voltage decrease signal PSL from an H-level into an L-level, the abnormality signal GL changes from an L-level to an H-level. The change to the H-level of the abnormality signal GL causes the output of the logical product operator AND of the gate IF circuit 61 to be an L-level. When the output of the logical product operator AND is at an L-level, the base current does not flow into the transistor Tr1. Thus, after a predetermined period of time has passed from the transition of the control power supply voltage decrease signal PSL from an H-level to an L-level, the transistor Tr1 and the transistor Tr4 are simultaneously in the OFF state.

The base terminal of the transistor Tr3 in the turning ON circuit at control power supply voltage decrease 62 receives the abnormality signal GL from the abnormality detecting means 55. Until a predetermined period of time passes from the transition of the control power supply voltage decrease signal PSL from an H-level to an L-level, the abnormality signal GL is at an L-level. Thus, base current does not flow into the transistor Tr3, causing the transistor Tr3 to be in the OFF state.

The base terminal of the transistor Tr2 of the turning ON circuit at control power supply voltage decrease 62 receives the control power supply voltage decrease signal PSL. The control power supply voltage decrease signal PSL changes from an H-level to an L-level when the control power supply voltage has decreased. When the control power supply voltage decrease signal PSL is at an L-level, base current does not flow into the transistor Tr2. Thus, the transistor Tr2 is in the OFF state.

When the transistor Tr2 turns OFF, base current flows into the transistor Tr4 through the pull up resistor R3 since the transistor Tr3 is in the OFF state. Thus, the transistor Tr4 turns ON.

Turning ON of the transistor Tr4 forces the gate signal G3U into an L-level irrespective of the ON/OFF state of the transistor Tr1.

The abnormality signal GL changes from an L-level to an H-level after a predetermined period of time from the moment of transition of the control power supply voltage decrease signal PSL from an H-level to an L-level.

When the abnormality signal GL changes to an H-level, base current flows into the transistor Tr3, turning ON the transistor Tr3. The turning ON of the transistor Tr3 stops the base current into the transistor Tr4, turning OFF the transistor Tr4.

As a result of the OFF states of both the transistor Tr1 and the transistor Tr4, the gate signal G3U changes to an H-level.

Consequently, in the normal state of the control power supply voltage, the gate signal G3U changes to an H-level or an L-level corresponding to the control signal S3U. On detecting an abnormality of the control power supply voltage, the gate signal G3U assumes an L-level for a predetermined time duration and then changes to an H-level.

Finally, operation will be described in the following in an abnormal case of the three-level inverter.

In the abnormal state of the three-level inverter, the abnormality signal GL is at an H-level. In this case, the logical product operator AND delivers a signal fixed to an L-level. As a result, base current does not flow into the transistor Tr1, and the transistor Tr1 is in the OFF state.

The base terminal of the transistor Tr3 of the turning ON circuit at control power supply voltage decrease 62 receives the abnormality signal GL at an H-level, turning ON the transistor Tr3. When the transistor Tr3 turns ON, the base current into the transistor Tr4 stops flowing, turning OFF the transistor Tr4. Here, the operation of the transistor Tr4 is not affected by the control power supply voltage decrease signal PSL.

Thus, in the abnormal case of the three-level inverter, the gate signal G3U is always at an H-level because the transistor Tr1 and the transistor Tr4 are both in the OFF state.

The circuit to generate the gate signal G4U for the switching element T4 has the same construction as the turning ON circuit at control power supply voltage decrease 62 shown in FIG. 6. The circuit to generate the gate signal G4U for the switching element T4, accordingly, operates in the same manner as the turning ON circuit at control power supply voltage decrease 62.

As described above, when the control power supply voltage decrease detecting means 56 detects decrease of the voltage of the control power supply, the switching elements T1 and T2 are in the OFF state. The switching elements T3 and T4 turn ON once and, after a predetermined period of time, turn OFF. This operation of the switching elements T3 and T4 prevents the switching elements T1 and T2 from being subjected to the voltage 2E of the DC power supply 1.

The gate IF circuit 61 and the turning ON circuit at control power supply voltage decrease 62 shown in FIGS. 5 and 6 are just examples of means for generating gate signals using control signals, an abnormality signal, and a control power supply voltage decrease signal. A circuit performing the same functions can be constructed using other electric or electronic elements and logic elements.

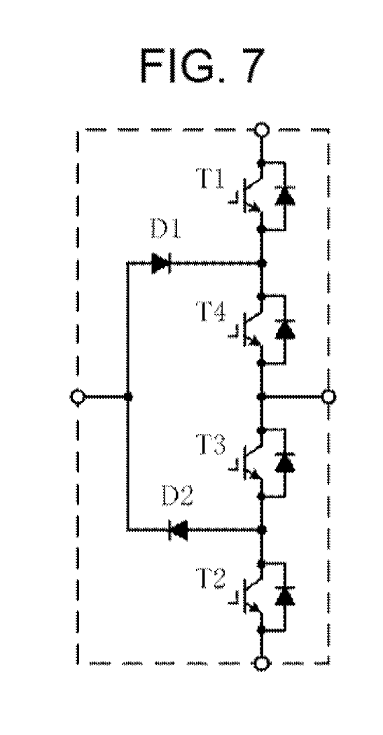

A switching leg for composing a three level inverter such as shown in FIG. 1 can have the structure as shown in FIG. 7. This switching leg comprises: a series circuit of the switching elements T1, T4, T3, and T2 each having an antiparallel-connected diode, connected in series in this order; a diode D1 with the cathode thereof connected to the connection point of the switching element T1 and the switching element T4; and a diode D2 with the anode thereof connected to the connection point of the switching element T3 and the switching element T2. The AC output terminal is connected to the connection point of the switching element T4 and the switching element T3. The middle potential terminal C is connected to the connection point of the anode of the diode D1 and the cathode of the diode D2.

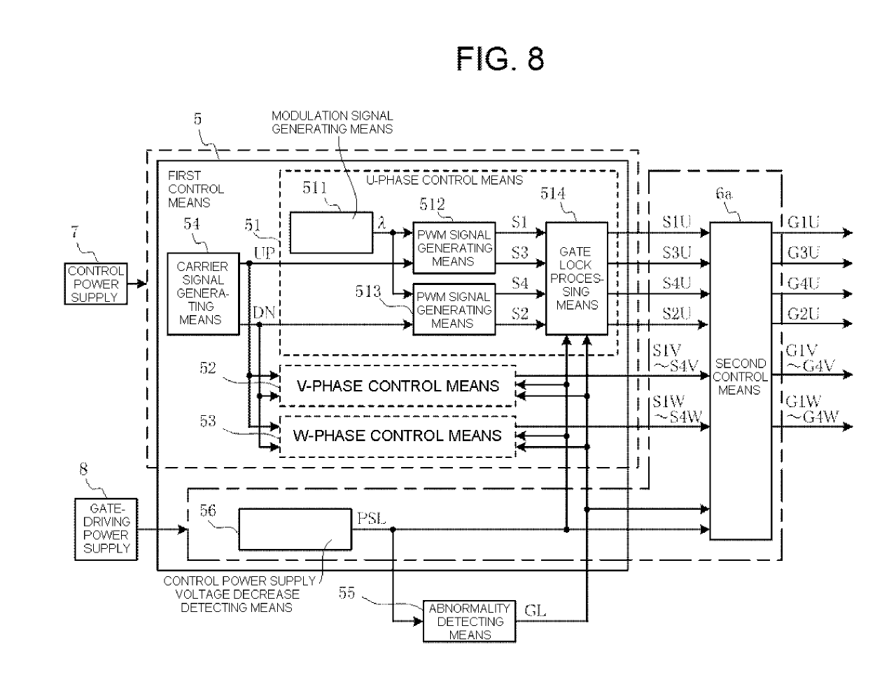

FIG. 8 is a block diagram to illustrate a control circuit of another embodiment of three-level power converting apparatus according to the present invention. In the control circuit of this embodiment, the abnormality detecting means 55 is disposed outside the first control means 5 and operates with a power supply other than the control power supply 7 and the gate-driving power supply 8.

The same functions and effects as those describe above are also obtained with the control circuit where the abnormality signal is delivered from the abnormality detecting means 55 disposed outside the first control means 5.

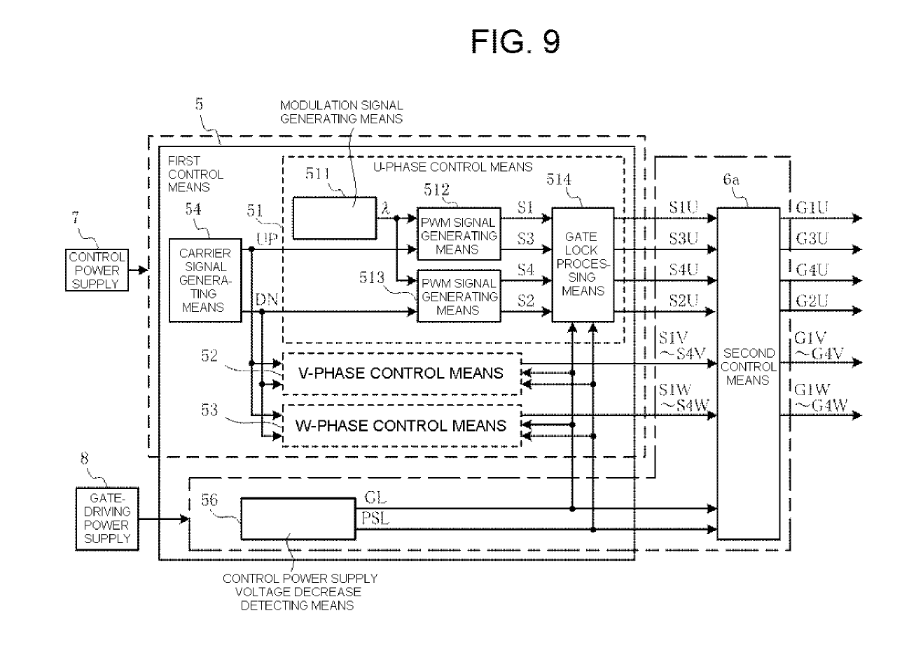

FIG. 9 is a block diagram to illustrate a control circuit of still another embodiment of three-level power converting apparatus according to the present invention.

In the control circuit of the embodiment, the control power supply voltage decrease detecting means 56, which operates with a gate-driving power supply 8, generates both a control power supply voltage decrease signal PSL and an abnormality signal GL. The abnormality signal GL changes to an H-level after a predetermined period of time from the transition of the control power supply voltage decrease signal PSL to an L-level. The same functions and effects as those described above are also obtained with the control circuit where the control power supply voltage decrease detecting means 56 generates both a control power supply voltage decrease signal PSL and an abnormality signal GL.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

What is claimed is:

1. A three-level power converting apparatus comprising:
a switching leg including:
a first circuit comprising a first switching element and a second switching element connected in series between a high potential terminal and a low potential terminal of a DC power supply, and
a second circuit comprising a third switching element and a fourth switching element connected in antiparallel with each other between a middle potential terminal and a middle connection point in the first circuit;
a first control means generating a first control signal for controlling the first switching element, a second control signal for controlling the second switching element, a third control signal for controlling the third switching element, and a fourth control signal for controlling the fourth switching element;
a first power supply for operating the first control means;
a second control means generating a first gate signal based on the first control signal, a second gate signal based on the second control signal, a third gate signal based on the third control signal, a fourth gate signal based on the fourth control signal; and
a second power supply for operating the second control means; wherein in a case in which an abnormality of the first power supply has occurred, the second control means generates first through fourth gate signals for turning OFF the first through fourth switching elements.

2. The three-level power converting apparatus of claim 1, further comprising: a power supply voltage decrease detecting means for detecting abnormality of the first power supply, the power supply voltage decrease detecting means being operated at the voltage of the second power supply.

3. The three-level power converting apparatus of claim 2, wherein the second power supply is a power supply for driving gates of the first through fourth switching elements.

4. The three-level power converting apparatus of claim 1, wherein in a case in which an abnormality of the first power supply has occurred, the second control means generates:
the first and second gate signals to substantially immediately turn OFF the first and second switching elements;
the third gate signal to turn the third switching element ON for a predetermined period of time, and to turn the third switching element OFF after expiration of the predetermined period of time; and
the fourth gate signal to turn the fourth switching element ON for a predetermined period of time, and to turn the fourth switching element OFF after expiration of the predetermined period of time.

5. The three-level power converting apparatus of claim 4, wherein the predetermined period of time in which the third and the fourth switching elements are in an ON state is longer than a period of time from a start of an OFF operation of the first switching element to completion of the OFF operation thereof, and is also longer than a period of time from a start of an OFF operation of the second switching element to completion of the OFF operation thereof.

6. The three-level power converting apparatus as claimed in claim 1, wherein the abnormality of the first power supply includes at least one of a stoppage of the first power supply or a decrease in voltage of the first power supply below a predetermined value.

7. A three-level power converting apparatus comprising:
a switching leg including:
a third circuit comprising a first switching element, a fourth switching element, a third switching element, and a second switching element, these switching elements being sequentially connected in series, the third circuit being connected between a high potential terminal and a low potential terminal of a DC power supply;
a first diode being connected between a middle potential terminal and a connection point of the first switching element and the fourth switching element;
a second diode being connected between the middle potential terminal and a connection point of the third switching element and the second switching element;
a first control means generating a first control signal for controlling the first switching element, a second control signal for controlling the second switching element, a third control signal for controlling the third switching element, and a fourth control signal for controlling the fourth switching element;
a first power supply for operating the first control means;
a second control means generating a first gate signal based on the first control signal, a second gate signal based on the second control signal, a third gate signal based on the third control signal, a fourth gate signal based on the fourth control signal; and
a second power supply for operating the second control means; wherein in a case in which an abnormality of the first power supply has occurred, the second control means generates first through fourth gate signals for turning OFF the first through fourth switching elements.

8. The three-level power converting apparatus of claim 7, further comprising: a power supply voltage decrease detecting means for detecting abnormality of the first power supply, the power supply voltage decrease detecting means being operated at the voltage of the second power supply.

9. The three-level power converting apparatus of claim 8, wherein the second power supply is a power supply for driving gates of the first through fourth switching elements.

10. The three-level power converting apparatus of claim 7, wherein in a case in which an abnormality of the first power supply has occurred, the second control means generates:
the first and second gate signals to substantially immediately turn OFF the first and second switching elements;
the third gate signal to turn the third switching element ON for a predetermined period of time, and to turn the third switching element OFF after expiration of the predetermined period of time; and
the fourth gate signal to turn the fourth switching element ON for a predetermined period of time, and to turn the fourth switching element OFF after expiration of the predetermined period of time.

11. The three-level power converting apparatus of claim 10, wherein the predetermined period of time in which the third and the fourth switching elements are in an ON state is longer than a period of time from a start of an OFF operation of the first switching element to completion of the OFF operation thereof, and is also longer than a period of time from a start of an OFF operation of the second switching element to completion of the OFF operation thereof.

12. The three-level power converting apparatus as claimed in claim 7, wherein the abnormality of the first power supply includes at least one of a stoppage of the first power supply or a decrease in voltage of the first power supply below a predetermined value.

13. An apparatus, comprising:
a plurality of switching devices;
a primary control device configured to generate control signals for the plurality of switching devices;
a primary power supply configured to supply power to the primary control device; and
a secondary control device configured to, based on detection of an abnormality in the primary power supply, generate compensating signals to the plurality of switching devices.

14. The apparatus of claim 13, wherein the compensating signals are configured to turn off selected ones of the plurality of switching devices in a predetermined sequence.

15. The apparatus of claim 13, further comprising a voltage abnormality detection device configured to detect a voltage abnormality in the primary power supply.

16. The apparatus of claim 13, further comprising a voltage abnormality detection device configured to detect a decrease in a voltage of the primary power supply to a level below a predetermined value, and to output a corresponding voltage abnormality detection signal.

17. The apparatus of claim 13, further comprising a switching device abnormality device configured to detect an abnormality in at least one of the plurality of switching devices.

18. The apparatus of claim 16, further comprising a switching device abnormality detection device configured to detect at least one of an overcurrent or an overheating in at least one of the plurality of switching devices, and to output a corresponding switching device abnormality signal.

19. The apparatus of claim 18, further comprising a secondary power supply configured to supply power to the secondary control device, the voltage abnormality detection device and the switching device abnormality detection device.

20. The apparatus of claim 19, wherein the secondary control device is configured to receive at least one of the voltage abnormality detection signal or the switching device abnormality signal, and to generate the compensating signals in response.
